(19) United States
(12) Patent Application Publication
(10) Pub. No.: US 2025/0117283 A1
(43) Pub. Date: Apr. 10, 2025

(54) POST-PRODUCTION PLATFORM SYSTEMS AND METHODS

(71) Applicant: NBCUniversal Media, LLC, New York, NY (US)

(72) Inventors: Joshua Marcik, Holland, PA (US); Hugues Dalton, Edgewater, NJ (US)

(21) Appl. No.: 18/630,751

(22) Filed: Apr. 9, 2024

Related U.S. Application Data
(60) Provisional application No. 63/589,043, filed on Oct. 10, 2023.

(51) Int. Cl. G06F 11/07; G11B 27/34; G11B 27/36

(52) U.S. Cl. CPC G06F 11/0793; G11B 27/34; G11B 27/36

(57) ABSTRACT

Systems and methods for efficient and reliable post-production editing are provided. Specifically, a central ingest system reduces processing and storage burdens by satisfying multiple workgroup requests for content via a single-stored version of the content and metadata supplied to each of the requesting workgroups. Further, a monitoring system provides metric data records that include metrics sources from a plurality of different metric sources associated with post-production working systems. These metric data records enable efficient and accurate diagnosis of problems and remediation actions, which may be implemented by the post-production platform.

### CROSS-REFERENCE TO RELATED APPLICATION

This application claims priority from and the benefit of U.S. Provisional Patent Application Ser. No. 63/589,043, entitled “POST-PRODUCTION PLATFORM SYSTEMS AND METHODS”, filed Oct. 10, 2023, which is hereby incorporated by reference.

### BACKGROUND

This disclosure relates generally to a platform that facilitates post-production, and more specifically to platform monitoring and post-production functionalities that provide efficient and reliable post-production collaboration.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Once production of content is complete, many post-production activities with respect to the produced content are performed. These activities are performed across different entities, teams, and personnel, resulting in many duplicative actions by these various post-production actors. Further, as may be appreciated, a significant number of electronic devices (e.g., servers, client computing device, virtual machines, etc.) and a vast number of software applications may be used in many different geographical areas to support these post-production activities. Unfortunately, the duplicative post-production activity may have a significant time, monetary, and processing cost. Further, the vast number of electronic devices and software applications used in a vast number of different geographies may result in a significant number of trouble points that may be difficult to identify based upon the vast number of variables that may exist from machine-to-machine, location-to-location, and/or task-to-task, etc.

Current third-party post-production electronic devices, applications, and services provide siloed data that is limited to the specific platform or service and lack a holistic view that enables users, managers or administrators to monitor content life cycle, usage, performance, and costs and lack an ability to provide metrics using a single interface.

Accordingly, a need exists to create an application or hub that allows the automated creation of assets for ingest for content creation and for delivery to any endpoint along with collecting and reporting aggregated data across multiple platforms and services to enable managers and administrators to diagnose problems, allow self-healing of services, provide accurate billing and evaluate and predict needs.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In accordance with an embodiment of the present disclosure, a tangible, non-transitory, computer-readable medium, includes computer-readable instructions that, when executed by one or more processors of one or more computers, cause the one or more computers to: ingest content into a location at a video storage platform; receive a request, from a post-production workgroup to record a copy of the content; and in response to receiving the request, provide metadata that provides an indication of the location to the post-production workgroup in lieu of the copy of the content.

In accordance with an embodiment of the present disclosure, a tangible, non-transitory, computer-readable medium, comprising computer-readable instructions that, when executed by one or more processors of one or more computers, cause the one or more computers to: receive metric information associated with a post-production computing device from a plurality of metric sources; aggregate the metric information from the plurality of metric sources; and generate and store metric record for the post-production computing device, comprising the aggregated metric information from the plurality of metric sources.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a system diagram, illustrating a platform monitoring system for identifying trouble spots within a computing environment, in accordance with certain embodiments;

FIG. 2 is a flowchart, illustrating a process for populating one or more datastores with metrics from a plurality of metric sources, in accordance with certain embodiments;

FIG. 3 is a flowchart, illustrating a process for identifying and acting upon real-time and/or historical data populated into the one or more datastores, as described with respect to FIG. 2, in accordance with certain embodiments;

FIG. 4 is a schematic diagram, illustrating use of a Central Ingest system for efficient ingest of content streams, in accordance with certain embodiments;

FIG. 5 is a schematic diagram, illustrating an example 500 of single channel stream origination, despite multiple recording requests; in accordance with certain embodiments; and

FIG. 6 is a schematic diagram, illustrating an example Central Ingest GUI 600, in accordance with certain embodiments.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As noted above, there remains a need for a solution that is able to monitor a vast number of variables within a platform that includes a significant number of different types of systems (e.g., on premises systems and/or cloud-based systems; client computing devices, server computing devices, and/or virtual machines; etc.) used for different types of tasks via different types of software applications.

### Harvest Monitoring System

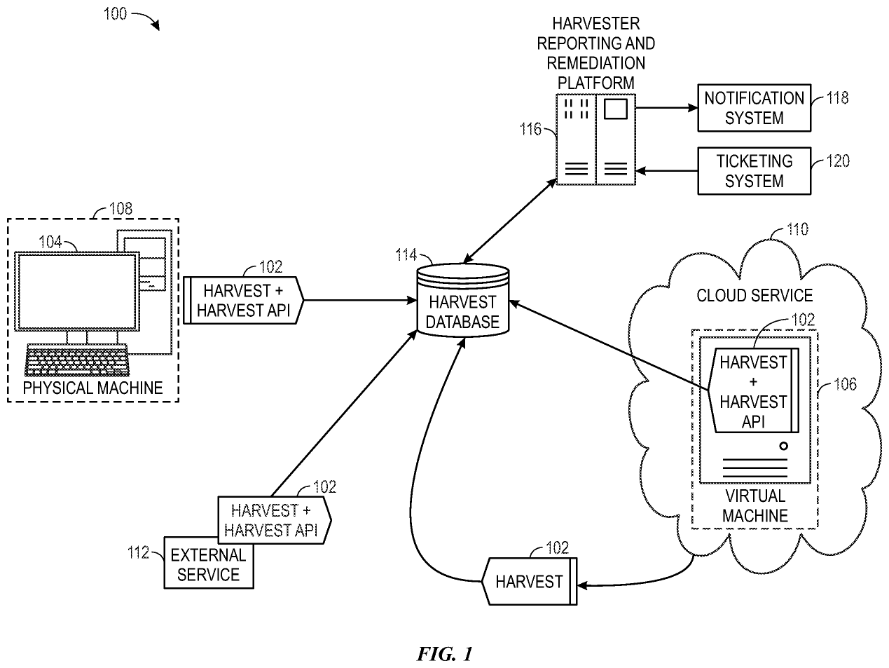

FIG. 1 is a system diagram, illustrating a platform monitoring system 100 that enables real-time platform monitoring, enabling identification and remediation of trouble spots within a computing environment, in accordance with certain embodiments. As illustrated, the harvest service 102 can be deployed on physical 104 or virtual machines 106, either on-premises 108 and/or via cloud services 110 to periodically collect information from those sources. The periodicity of data collection for the machines can be customized based on system criticality and services needed to be monitored (e.g., every half hour, every hour or longer). For example, the harvest service 102 can be deployed on multiple virtual machines 106 to collect system information and backend cloud infrastructure and application(s) performance. The virtual machine 106 information may indicate metric information, such as information that may be gleaned from the operating system, including, but not limited to, CPU utilization, RAM utilization, GPU utilization, network speed and/or disk utilization. The harvest service 102 can also gather additional tangential information, such as network information including the amount of data received, transmitted, or lost by the virtual machine from a remote user accessing the platform (e.g., PC over IP). This could enable, for example, quick diagnosis of latency and/or lagging issues reported by users, cutting down the time it takes to solve issues.

To illustrate an example of the troubleshooting capabilities, a user may indicate that the user is not receiving expected performance from a virtual machine 106 (e.g., sluggish results). The harvest service 102 can quickly measure the latency between the virtual machine 106 and an electronic device that it is communicating with (e.g., a post-production server) and determine the packet loss between the virtual machine and post-production server. If both the latency and the packet loss values are within range, the system 100 and/or an administrator can quickly determine that neither latency nor packet loss is contributing to the performance problems. Because of the data exposed by the harvest service 102, the system 100 and/or administrator can determine a different root cause. For example, the root cause may be determined to be an overtaxing of assigned resources of the virtual machine. This may be determined by CPU, RAM, and/or GPU utilization metrics received by the harvest service 102. If for example, the utilization is relatively close to 100% (e.g., closer than a threshold percentage to 100%), this will enable the system 100 and/or administrator to quickly diagnose that the problem is not connectivity but instead the virtual machine 106 being overtaxed.

In addition to system information, the harvest service 102, may collect information about a specific application of interest to the user. For example, post-production personnel may utilize software such as particular content editing software and/or particular storage mount points. The harvest service 102 may also gather information from a provider of the cloud service 110, including what resource and native function is utilized. The information gathered by the harvest service 102 is timestamped, indicating the time periods of utilization to correlate to various types of activities or resource usage in order to provide a single-pane snapshot of a user's activity. The data is stored in a data lake (e.g., harvest database 114) and retrievable for the duration of the lifecycle of the VM or native function (e.g., via the harvester reporting and remediation platform 116).

The harvest service 102 may also gather information from other external services 112, as well. For example, the harvest service 102 may be communicatively coupled with an Internet Service Provider to obtain Internet availability metrics, utility providers to obtain utility consumption and/or availability, etc.

In addition to providing an informational snapshot for real-time activity at any time point, the data gathered by the harvest service 102 generates metrics for machines across the system 100. Thus, system-wide information, such as usage metrics, including the maximum number of users logged in at any given time, software consumed, number of hours used per business unit or show, user session times and overall performance of the platform may be stored. All information gathered from the system 100 is tagged with a business unit name and sub function identifiers, such as a machine name or show produced to allow accurate billing of the resource. The services, using a custom-built algorithm, allows all cloud services consumed on the platform to be broken down and re-allocated to the business units based on the size of the deployment and actual utilization. The financial metrics derived from the system 100 allow not only accurate bill back of the platform but also gives a tool for the users to track their spend against budgeted numbers and provides financial guidance when planning for future budget cycles. Having that clarity allows companies to buy resources in bulk and reallocate costs efficiently back to the groups.

The metrics may be provided via the harvester reporting and remediation platform 116, which is communicatively coupled to the harvest database 114. As mentioned above, both real-time data metrics and historical data metrics may be provided via the harvester reporting and remediation platform 116, based upon the records populated in the harvest database 114. In some embodiments, the harvester reporting and remediation platform 116 may proactively identify (e.g., via analysis using a rules engine and/or machine learning) trouble spots within the system 100. When such trouble spots are identified, the harvester reporting and remediation platform 116 may trigger a remedial action. For example, the harvester reporting and remediation platform 116 may trigger a notification to be sent (e.g., email) via the notification system 118 (e.g., email system) or may trigger a ticket to be generated for an IT ticket system that records tickets for actions to be completed. In some embodiments, the harvester reporting and remediation platform 116 may provide metric subsets from the records populated in the harvest database 114 based upon user queries submitted to the harvester reporting and remediation platform 116 via a graphical user interface (GUI) that provides a query affordance to access this information.

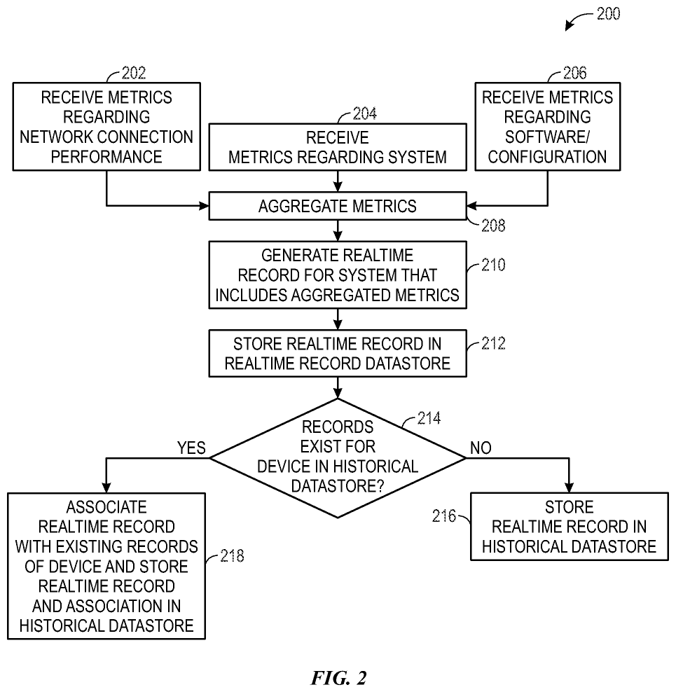

FIG. 2 is a flowchart, illustrating a process 200 for populating one or more datastores with metrics form a plurality of metric sources, in accordance with certain embodiments. The process begins with receiving metrics from a plurality of different metric sources. For example, metrics may be received regarding: network performance (block 202), system-level status (block 204), and/or software and/or system configuration (block 206). Data from additional metric sources may be provided.

The received metrics are aggregated (block 208) and a real-time record is generated and indicated as associated with a particular system being monitored (block 210). The generated record may be stored in a real-time record datastore (block 212).

As mentioned above, historical records are also kept and may be used for trouble spot diagnosis and/or diagnosis machine learning model training. To store the historical data, a determination may be made as to whether existing records associated with the system being monitored exist (decision block 214). If not, the real-time record is stored without association to other records of the system (block 216). However, if records for the device do exist, the real-time record may be associated with the existing records and stored with the association in the historical datastore (block 218)

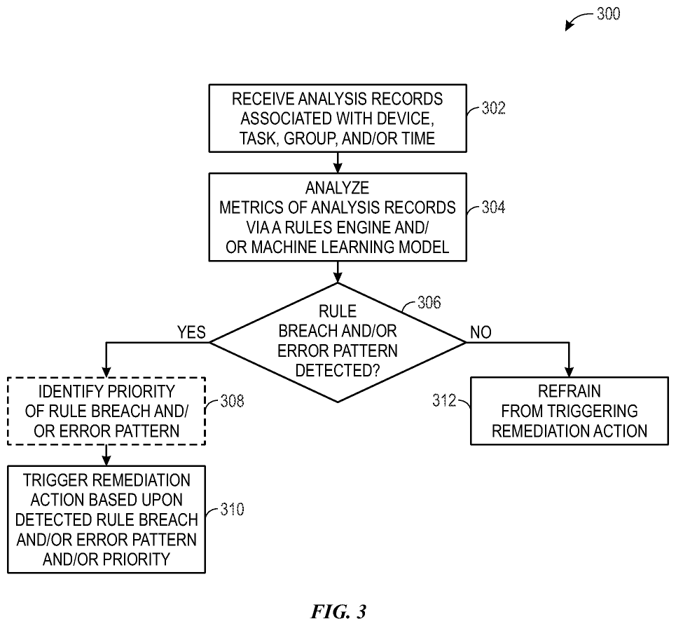

FIG. 3 is a flowchart, illustrating a process 300 for identifying and acting upon real-time and/or historical data populated into the one or more datastores, as described with respect to FIG. 2, in accordance with certain embodiments. Upon the real-time records and historical records being populated, analysis records may be identified/received to identify and/or diagnose trouble spots (block 302). For example, the analysis records could be identified based upon a particular characteristic to analyze, such as records associated with a particular device, device-type, task, personnel group, time, etc.

Metrics in the analysis records are analyzed to identify conformity with rules of a rule engine and/or patterns associated with the errors as defined in training data of a machine learning model (block 304). A determination is made as to whether breached rules and/or patterns associated with an error are detected (decision block 306). If so, a problem spot and/or a diagnosis of the problem spot may be identified.

In such a case, a priority associated with the problem spot (e.g., error) may optionally be identified (block 308). For example, the prioritization may be based upon any number of factors including: a type of error, an identified source of the error, the particular rule breached and/or pattern observed, an amount of time that the error has been present, etc. A remediation action may be triggered based upon the trouble spot and/or priority (block 310). For example, lower-priority errors may result in triggering a notification, such as an email, while relatively higher-priority errors may trigger a ticket to be generated, potentially along with a notification. In some embodiments, the system 100 may have a self-healing fix for particular types of errors. For example, the system 100 may launch an application that is required to be running for a process when the application is found not to be running. If the self-healing fix is not successful, then subsequent remedial measures may be implemented. If no rule breach or pattern associated with errors is detected (at decision block 306), the system 100 may refrain from triggering a remedial measure (block 312).

### Platform Central Ingest

In addition, the system 100 allows for ingest of material, stitching of content and creation of deliverables via automation. A user can at any time monitor the life cycle of the assets being created or delivered through a custom dashboard. The custom-built application programming interface (API) allows the automation platform to integrate with any vendors like Avid, Telestream, Signiant and EVS to create workflows for content creation and delivery to any end points worldwide. Those workflows are also integrated with cloud native cognitive services allowing for automated metadata enrichment like transcription services, facial and object recognition, and auto assembly of assets. Data for all workflows and jobs processed is stored alongside the harvest service 102 data for users to derive metrics and generate productivity stories based on job completed.

Central Ingest is the ability to ingest, in real-time, content into the platform as orchestrated through a graphical user interface (GUI). In traditional post-processing, when a person is working on premises, a feed, such as a Serial Data Interface (SDI) feed is fed from a video router into a server that decodes the SDI feed and encodes the feed to a user selected codec. The re-encoded feed is dropped into storage so that people can edit the content. However, there is little to no transparency about what recordings other people have made, so duplicate recordings are common. It is also difficult to coordinate what happens to the edited recordings and limits recordings to specific geographical locations.

Central Ingest removes geographical boundaries for feed origination. A feed can be sourced from anywhere in the world and be recorded using the application providing a single GUI allowing a user to see permissioned channels. The permissioned channels may be filtered from a larger set of channels based on user permissions. For example, while an administrator may see all channels, a technical operator may see regional channels. Users associated with a specific station (e.g., “Broadcast Channel 1” users) may see only station-specific channels.

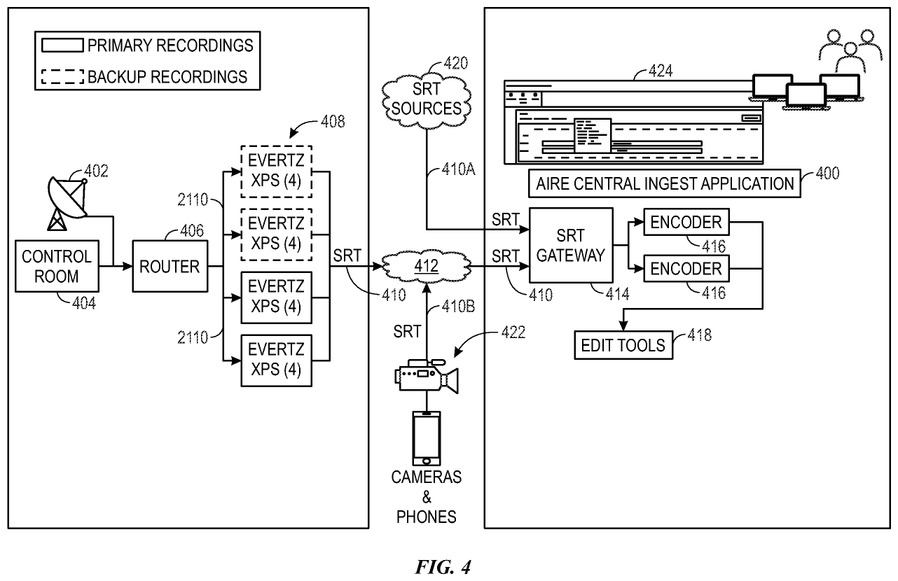

FIG. 4 illustrates use of a Central Ingest system 400 for efficient ingest of content streams, in accordance with certain features. As shown in FIG. 4, streams of available channels are provided from a satellite 402, control room 404, or another source, where they are received through a router 406. The channels are then fed into a live video encoders 408 (e.g., a series of EVERTZ XPS encoders) to prepare the content for efficient network transport. In some embodiments, as illustrated, multiple encoders 408 may work in parallel to support encoding of multiple channels of content (e.g., here 8 primary channels and 8 backup channels). In the illustrated example, the encoders 408 may take in the channels in the form of a Society of Motion Picture and Television Engineers (SMPTE) 2110 signal and/or an SDI signal and converts it to a Secure Reliable Transport (SRT) video transport signal 410. SRT signals are compressed signals that can be transmitted over the Internet. An SRT signal can be encoded as an H.264 or a H.265 signal with a user designated bitrate. The SRT signal is sent over the Internet 412 to an SRT gateway 414. The SRT gateway 414 takes the SRT signal 410 and sends it to a set of encoders/decoders 416. Encoders/decoders 416 decode the SRT stream 410 and re-encode it at a selected codec and makes it available for editing (via edit tools 418) via a centralized storage and asset management repository.

Additionally and/or alternatively SRT streams 410A and/or 410B may be ingested from additional sources. For example, SRT stream 410A is sourced from a cloud provider 420, while SRT stream 410B is sourced from mobile device and/or field camera 422. Similar to SRT stream 410, streams 410A and 410B may be recorded, enabling anyone with a phone and/or communication-ready camera to provide content to the platform.

The Central Ingest System 400 includes a graphical user interface (GUI) 424 that coordinates recording of channel streams, delivery of the recording, and process-triggering to trigger processing with respect to the recording. The GUI 424 that may provide a graphical scheduler. The graphical scheduler may indicate (e.g., on the y-axis) the ingest sources (i.e., permissioned channels) that are available for recording. The scheduler indicates (e.g., on the x-axis) a linear timeline. Through the user interface, a user may designate a specific start and end time for a particular ingest source for recording. This will schedule a recorder to make a copy of a feed streaming into the recorder from the gateway 414. Since every user looking to record available channels is working off the same GUI 424, the software will prevent duplicate recordings and present an indication to the operator that the channel stream is already being recorded and allows the user to proceed or cancel the recording, avoiding a duplicate recording. In this scenario, content (e.g., the Today show) is recorded once for all users of the company, and metadata related to the content (e.g., show name, unique identifier, custom metadata used by a show) is provided to anyone else who needs to access the record as will be discussed in more detail below. As may be appreciated, this may provide significant processing efficiencies, as duplicative copies are not created and stored.

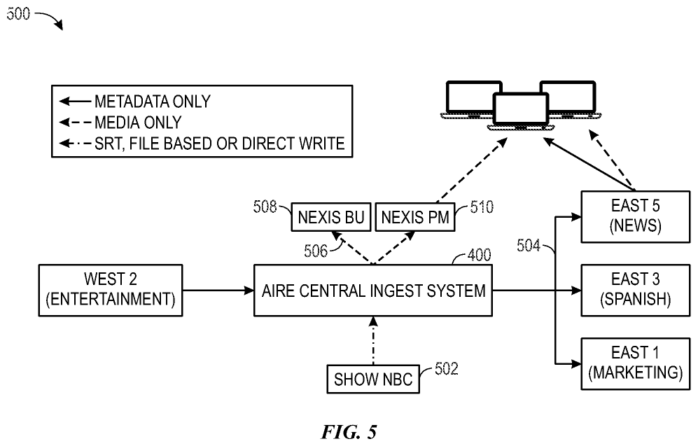

Turning to FIG. 5, FIG. 5 illustrates an example 500 of single channel stream origination, despite multiple recording requests. In the example 500 shown in FIG. 5, assume EAST 1, EAST 3, and EAST 5 are workgroups that would each like to access a recording of Show NBC 502, which is ingested into the Central Ingest System 400 via an SRT signal, as discussed above with respect to FIG. 4. Once an initial recording has been requested (e.g., by one of EAST 1, EAST 3, or EAST 5), metadata 504 associated with the recorded media (e.g., recording of Show NBC 502) is sent to the requesting workgroup in real time. Upon subsequent requests for a recording of Show 502 (e.g., by other of the workgroups EAST 1, 3, and 5), the metadata 504 is sent to the additional requesting workgroups as well, in real-time as the recording occurs. The metadata 504 provides an indication of a location (e.g., a link) to the recorded media 506, which is stored on a primary video storage platform 508 and backup video storage platform 510) (e.g., Avid Nexis Primary and Avid Nexis Backup Application Centric Infrastructures (ACIs), respectively), which enable EAST 1, EAST 3, and EAST 5 to simultaneously edit the growing recorded media for production or post-production at the same time. Further processing may be requested by EAST 1, EAST 3, or EAST 5 with respect to the recorded media upon start or completion of recording, including that the media and/or metadata resulting from the processing be transmitted to a particular destination.

In an aspect, the permissioned channels that are available for recording may be designated as (i) always on or (ii) on-demand. An always on channel is on and immediately available for recording. An on-demand channel is off unless a recording is scheduled for the channel, and then, the channel will be configured to turn on 5 minutes (or a time threshold) before the recording begins to enable the recording to occur. After the recording is finished, the channel will power down. This logic reduces the cost of having always on channels.

In a hybrid environment where some channels are always on and some are also available on demand, the software via a custom algorithm may assess how many channels are available to record right away in case of breaking news and may automatically spin up additional channels without user intervention. That feature is customizable to allow the user to decide how many channels should be spun up when existing numbers of channels reach a certain percentage of utilization.

The software can also be configured to allow the user to let Central Ingest decide which channel to use for the recording. When managing hundreds of recording channels, it can be difficult to find a channel available to record without cycling through all of them, which is time consuming. By letting the application select the channel, the software can be more efficient and leverage an open channel, driving savings by not having to turn on additional resources. It also allows the user concentrate on scheduling the recordings and generates productivity.

Channel usage is collected via a custom API that tracks the number of recordings per channels over a period of time to be set by requestor. This information will enable user to decide if the channels should be set to be always on or on demand. By making such dynamic changes based upon this data, additional processing efficiencies and monetary savings may be achieved.

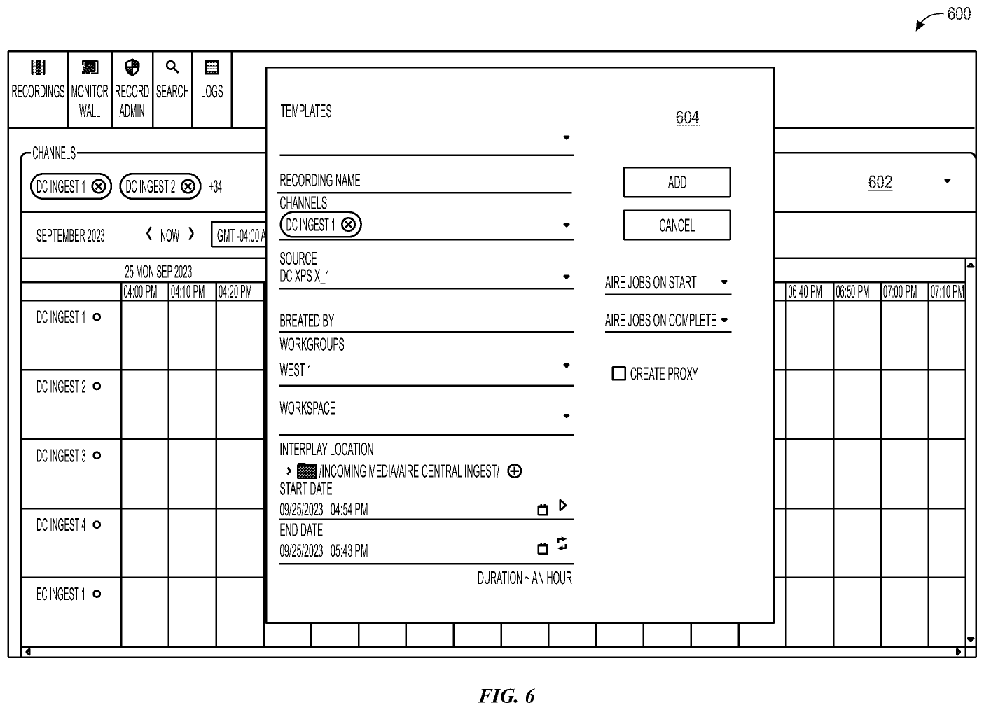

FIG. 6 is a schematic diagram, illustrating an example Central Ingest GUI 600, in accordance with certain embodiments. The GUI 600 includes a graphical schedule 602 illustrating channel recordings scheduled at particular times. The dialog box 604 provides affordances for coordinating recording requests by particular workgroups. In the illustrated example, Workgroup WEST 1 is requesting a recording of “DC Ingest 1” sourced from “DC XPS X_1”. As mentioned above, for each workgroup requesting a recording of the same content, a pointer and/or link to a single location (e.g., here, “/Incoming Media/AAIR Central Ingest/[Filename]”) will be provided in metadata. Thus, a single copy is ingested at the specified location, rather than providing copies to each workgroup. As may be appreciated, this provides significant storage savings, processing efficiencies, and network utilization efficiencies. The dialog box 604 includes affordances that allow a user to specify when the metadata should be sent to the workgroup, for example allowing the metadata to be sent upon start of the recording, upon completion of the recording, or both. Additionally, the dialog box 604 allows the user to specify start and end times for the recording, the location, proxies, etc.

The technical effects of the present disclosure include a platform monitoring system that generates custom aggregations of performance metrics and utilizes these metrics to pinpoint and alert of potential trouble points and/or root causes of experienced issues. Further, the platform may provide efficient ingest and processing of content files, resulting in reduced duplicative work, which may reduce processing requirements across the platform.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A tangible, non-transitory, computer-readable medium, comprising computer-readable instructions that, when executed by one or more processors of one or more computers, cause the one or more computers to:
ingest content into a location at a video storage platform;
receive a request, from a post-production workgroup to record a copy of the content; and
in response to receiving the request, provide metadata that provides an indication of the location to the post-production workgroup in lieu of the copy of the content.

2. The tangible, non-transitory, computer-readable medium of claim 1 comprising computer-readable instructions that, when executed by the one or more processors of the one or more computers, cause the one or more computers to:
receive a second request, from a second post-production workgroup to record a second copy of the content; and
in response to receiving the second request, provide the metadata that provides the indication of the location to the post-production workgroup in lieu of the second copy of the content.

3. The tangible, non-transitory, computer-readable medium of claim 1 comprising computer-readable instructions that, when executed by the one or more processors of the one or more computers, cause the one or more computers to:
ingest a second content into a second location at the video storage platform;
wherein a first source for the content and a second source of the second content are different from one another.

4. The tangible, non-transitory, computer-readable medium of claim 3, wherein:
the first source comprises an encoder associated with a broadcast control room, a broadcast satellite, or both; and
the second source comprises a cloud provider, camera, phone, or any combination thereof.

5. The tangible, non-transitory, computer-readable medium of claim 1 comprising computer-readable instructions that, when executed by the one or more processors of the one or more computers, cause the one or more computers to:
ingest the content into the location at the video storage platform, by:
receiving the content at one or more ingest encoders in a first format;
encoding the content based on a transfer format via the one or more ingest encoders;
transferring the encoded content over a network to an ingest gateway;
receiving and encoding the content from the ingest gateway into an editing format suitable for editing via post-production workgroups; and
storing the content in the editing format at the location of the video storage platform.

6. The tangible, non-transitory, computer-readable medium of claim 5, wherein:
the first format comprises a Society of Motion Picture and Television Engineers (SMPTE) 2110 format, a Serial Data Interface (SDI), or both; and
the transfer format comprises a Secure Reliable Transport (SRT) format.

7. A tangible, non-transitory, computer-readable medium, comprising computer-readable instructions that, when executed by one or more processors of one or more computers, cause the one or more computers to:
receive metric information associated with a post-production computing device from a plurality of metric sources;
aggregate the metric information from the plurality of metric sources; and
generate and store a metric record for the post-production computing device, comprising the aggregated metric information from the plurality of metric sources.

8. The tangible, non-transitory, computer-readable medium of claim 7, comprising computer-readable instructions that, when executed by the one or more processors of the one or more computers, cause the one or more computers to:
analyze the metric record to identify whether the aggregated metric information breaches a post-production compliance rule, contains a pattern associated with a post-production processing error, or both; and
when the aggregated metric information breaches the post-production compliance rule, contains the pattern associated with the post-production processing error, or both, implement a remediation action.

9. The tangible, non-transitory, computer-readable medium of claim 8, wherein the remediation action comprises:
providing an email;
restarting a service or application;
re-running a service or application;
installing a service or application;
generating an Information Technology ticket in a ticketing system; or
any combination thereof.

10. The tangible, non-transitory, computer-readable medium of claim 8, comprising computer-readable instructions that, when executed by the one or more processors of the one or more computers, cause the one or more computers to:
identify that the aggregated metric information contains the pattern and that the pattern comprises a status of a service or application that has been associated with previous post-production processing errors; and
in response, implement the remediation action, wherein the remediation action comprises:
restarting the service or application;
re-running the service or application;
installing the service or application; or
any combination thereof.

11. The tangible, non-transitory, computer-readable medium of claim 8, comprising computer-readable instructions that, when executed by the one or more processors of the one or more computers, cause the one or more computers to:
identify a priority associated with the post-production compliance rule, the pattern, the post-production processing error, or any combination thereof; and
select the remediation action from a plurality of available remediation actions based upon the identified priority.

12. The tangible, non-transitory, computer-readable medium of claim 8 comprising computer-readable instructions that, when executed by the one or more processors of the one or more computers, cause the one or more computers to:
identify the pattern associated with the post-production processing error via machine learning trained on historical metric data and associated errors, applied to the metric record.

13. The tangible, non-transitory, computer-readable medium of claim 8, wherein the metric information comprises:
network connection performance information;
system utilization information;
software configuration information; or
any combination thereof.

14. The tangible, non-transitory, computer-readable medium of claim 13, wherein the system utilization information comprises:
central processing unit (CPU) utilization metrics;
random access memory (RAM) utilization metrics;
graphics processing unit (GPU) utilization metrics; or
any combination thereof.

15. A system, comprising:
an ingest system, comprising:
a video storage platform;
one or more ingest encoders;
an ingest gateway; and
one or more outbound encoders
wherein the ingest system is configured to:
ingest content into a location at a video storage platform, by:
receiving the content at the one or more ingest encoders in a first format;
encoding the content based on a transfer format via the one or more ingest encoders;
transferring the encoded content over a network to the ingest gateway;
receiving and encoding the content from the ingest gateway into an editing format suitable for editing via post-production workgroups;
storing the content in the editing format at a location of the video storage platform;
receive a request, from a post-production workgroup to record a copy of the content; and
in response to receiving the request, provide metadata that provides an indication of the location to the post-production workgroup in lieu of the copy of the content.

16. The system of claim 15, comprising:
a monitoring system, configured to:
receive metric information associated with a post-production computing device from a plurality of metric sources;
aggregate the metric information from the plurality of metric sources; and
generate and store a metric record for the post-production computing device, comprising the aggregated metric information from the plurality of metric sources.

17. The system of claim 16, wherein the monitoring system is configured to:
identify a business unit name, sub function identifier, or both associated with use of the post-production computing device corresponding to the metric information; and
associate the business unit name, sub function identifier, or both to the metric record.

18. The system of claim 17, wherein the monitoring system is configured to generate a graphical user interface (GUI) that provides an indication of:
a bill back amount for the business unit name, sub function identifier, or both;
resource utilization metrics for the business unit name, sub function identifier, or both; or
both.

19. The system of claim 18, wherein the business unit name, sub function identifier, or both, indicates a particular show title of the content.

20. The system of claim 15, wherein:
the first format comprises a Society of Motion Picture and Television Engineers (SMPTE) 2110 format, a Serial Data Interface (SDI), or both; and
the transfer format comprises a Secure Reliable Transport (SRT) format.
